(19) United States
(12) Patent Application Publication
(10) Pub. No.: US 2013/0290135 A1
(43) Pub. Date: Oct. 31, 2013

(54) REQUEST FOR PROPOSAL SYSTEM AND METHOD FOR REAL ESTATE MANAGEMENT

(71) Applicant: Allen Borza, Lake Worth, FL (US)

(72) Inventor: Allen Borza, Lake Worth, FL (US)

(21) Appl. No.: 13/849,538

(22) Filed: Mar. 24, 2013

Related U.S. Application Data
(60) Provisional application No. 61/615,251, filed on Mar. 24, 2012.

(51) Int. Cl. G06Q 30/06

(52) U.S. Cl. CPC G06Q 30/0611
USPC 705/26.35; 705/26.4

(57) ABSTRACT

A system and method prepares and distributes structured Requests for Proposal (“RFPs”) to qualified vendors and collects proposals responsive to such RFPs, The system includes a tool, for creating Statements of Work (SOW) that are consistent with the RFP and with other SOWs. The vendors submit bids responding to the SOW in the RFP. The bids are organized into an easily reviewed summary having line by line comparisons of the various bids and detailed proposals, along with vendor compliance documents, compiled into a finished report.

### CROSS-REFERENCE TO RELATED APPLICATIONS

This application claims priority to U.S. Provisional Application Ser. No. 61/615,251, filed Mar. 24, 2012, the contents of which are hereby incorporated in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Endeavor

This invention relates to a system including a computer assisted business method for generating requests for proposals (“RFPs”) for products and services and submissions of proposals responding thereto. More specifically this invention relates to a method allowing property managers to request proposals for products and services to be provided or performed regarding real property and allowing vendors to submit proposals for supplying such products/services in an efficient and time conserving manner.

2. Background Information

Management of commercial and residential real estate, such as for example apartment complexes, commercial office buildings, malls, hotels, municipal buildings, community associations and the like, is a complex task. Property management tasks, in addition to satisfying owner and tenant needs, include managing building space inventory, tracking lease provisions, landscaping and dealing with various vendors to make repairs and maintaining the property premises. Such repairs and maintenance range from resolving emergencies to relatively mundane tasks like assigning and monitoring cleaning responsibilities and making repairs (e.g. changing a light bulb).

Heretofore, property management has been performed largely on a manual basis by the owner/landlord of a property or a management company employed by the owner. Problems often arise during the seemingly simple, but deceptively difficult, tasks of acquiring and carrying out repairs and maintenance. For example, a property manager or owner would like to effect construction, repairs and maintenance in the most efficient manner at the lowest cost by either using its own personnel or hiring outside contractors on the most cost effective basis. Finding the best vendor or service provider is difficult and time consuming, involving requesting quotes and locating vendors that are reliable and dependable and available. Further complicating this process, states have begun regulating this industry. In some states, for example Florida, property management is regulated and complying with local laws becomes a difficult and cumbersome task.

Management problems become more complex where a property manager manages a number of properties which may be in the same city or town or in different cities, states or countries. In such cases, the property manager may wish to control or monitor management of some or all of the properties from a central location. This would provide the property manager with more comprehensive information as to the status of its properties and better control over management and costs.

The expansion of the Internet over the past 2 decades has facilitated many changes in commerce, including the sales and purchases of services and products. Several of these Internet based online commerce systems have been applied in various ways to the well-established systems for submitting requests for proposals, RFPs, and for submitting proposals or bids in response. For example, eBay, Overstock.com and similar websites provide online auction or bidding systems. Typically, eBay is most suitable for items classically traded in garage sales, flea markets in pawnshops. It does allow users to rate vendors in order to help other purchasers better select from whom to purchase products or services. However, eBay is really not suitable for large-scale projects and does not provide an adequate system for defining an RFP or SOW or for adequately responding to one.

Craigslist also provides a very generalized system for requesting proposals or submitting bids or offers. It is very limited in its ability to screen solicitors and vendors, and provides no details whatsoever regarding projects. Craigslist is essentially a billboard that serves to place parties in communication with one another. Angie's list allows members to rate various vendors. These systems may be useful in selecting very generally a vendor in a given industry. However, it provides very little in the way of allowing a solicitor issuing an RFP to interact with vendors to submit bids in order to simplify and facilitate the process.

Large companies within large industries sometimes establish methods of receiving bid proposals. For example, a large company will post positions available and invite persons seeking employment to submit a job application. Often, applicants submit their resumes in addition to filling in fields in a form. As a result, the selection process becomes muddled. Further, even when specific fields must be entered by an applicant, answers may often be ambiguous. Further, there is no method for a potential employer to readily rate or double check claimed credentials. This example comes from the job market, not markets such as construction. However, the RFP and bid submission process is very analogous.

One system to improve the purchasing process that has become more common with online and Internet systems, has been product comparison charts. For example, many websites provide comparison charts for cell phones and cell phone service providers. This allows a purchaser to very quickly identify the pros and cons of a particular product or a cell phone carrier service. Similarly, online electronics stores often allow shoppers to compare features of computers or other products. Such comparison charts are extremely useful for purchasers. Unfortunately, comparison charts are not typically practical for the RFP submission process characteristic with real property management companies, construction companies, government contractors and other industries. Projects for which RFPs may be issued are typically very complex and very unique. Similarly, vendors submitting bids in response to an RFP typically have their own personalized, unique manner of explaining how they propose to complete a project. Different vendors will not break down and itemize a project in the same fashion. Thus, when a company who has submitted an RFP receives bid proposals. There is no adequate way to perform side-by-side comparisons similar to those we have become accustomed to using when selecting cell phones, computers and other devices. Instead, anyone receiving bid submissions must perform a very detailed time intensive and knowledge intensive review of all the submissions.

Heretofore, no system or method has existed that provides a property owner or property manager with the capability to carry out the necessary management functions on a comprehensive basis using computer aided resources pertaining to finding and evaluating qualified vendors. In particular, a need exists to enable the property owner or property manager to efficiently request and receive bids for various maintenance and repair projects in a timely manner from vendors known to be reliable and that are known to provide satisfactory products and services. More specifically, the current manual process of obtaining bids does not produce a cohesive format that easily compares vendors, often times forcing the manager to create their own spreadsheets and documents to compare vendors and their bids.

### SUMMARY OF THE INVENTION

Accordingly, objects of the present invention include providing a system and method for assisting in the creation of requests for proposals (RFPs) by property managers or other solicitors having responsibility for acquiring or assisting in the acquisition of products and services, notification of vendors of the RFP, submissions of proposals in responses thereto, and facilitating the selection of a vendor to fulfill such proposal.

The present invention relates to a system and method for organizing, automating, and facilitating the performance of property management processes. Specifically, the invention facilitates: the creation and distribution of RFPs, collection of responsive proposals including statements of work (SOWs) from qualified vendors, and the compilation of vendor responses into a proposal report that allows efficient analysis of the resulting submitted proposals.

The system and method may be useful for property owners, property managers, building staff, tenant office managers, and vendors who provide products and services to the property. In the system and method, communications may be carried out over the internet.

Aspects of the system and method may provide a structured RFP creation tool, plus industry wizards, to make Statements of Work (SOWs) more consistent. As used herein, the term “wizard” has its general meaning among computer programmers and generally refers to a program or part of a program that assists an operator in use of the program, such as for example in creating a document such as an RFP, SOW or other document.

The resultant RFP may be made available to registered and qualified vendors. Vendors may include construction companies, pool maintenance services, lawn maintenance services, electricians, plumbers, exterminators, painters, handymen, general and specific contractors and the like. Vendors may also include other service providers such as physical fitness instructors, attorneys, accountants, other professionals and the like.

Vendors may submit bids on the SOW and RFP generated by the soliciting property manager. Multiple proposals may thus be obtained. The proposals may be analyzed by the system software and readily compared to one another on and apples-to-apples basis. The property managers may compare the submissions using an itemized or otherwise organized composite summary of the submissions created by the system software. More detail, such as for example, vendor comments/details on various line items, references, vendor compliance documents such as state licenses, bond documents, vendor ratings and the like may be automatically compiled into a finished report.

The systems and methods as disclosed herein, in whole or in part, may be overseen or managed by a third party. For example, the property managers and vendors may access some or all aspects of the invention via a website or other centralized component and the website may be managed by a third party operator that provides some or all aspects of the invention. This company may then provide customer service, quality assurance and quality control to the users. Optionally, the company may provide vendor and/or property manager ratings, reviews, evaluations, escrows, mediation/arbitration and/or other services typically provided by a broker or other third party to a transaction.

These and other objects and advantages of the present invention will become apparent from a reading of the following specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

The Figures enumerated below correspond to the respective page numbers of the Drawings submitted herewith.

FIG. 1 is a flow chart of a system for preparing and responding to structured RFPs in accordance with the principles of the invention;

FIGS. 2 is a flow chart of a system for preparing and responding to structured RFPs in accordance with the principles of the invention;

FIG. 3 is a flow chart of a system for preparing a structured RFP in accordance with the principles of the invention;

FIGS. 4A-4I are an example of a proposal summary report in accordance with the principles of the invention;

FIGS. 5 is a flow chart of a process for selecting a structured proposal submitted in response to an RFP in accordance with the principles of the invention.

FIG. 6 is a function diagram of an overall model in accordance with the principles of the present invention;

FIG. 7 is a function diagram of a RFP creation model in accordance with the principles of the present invention;

FIG. 8 is a function diagram of a process for submitting the RFP to vendors in accordance with the principles of the present invention;

FIG. 9 is a function diagram of a process for qualifying and designating status of vendors in accordance with the principles of the present invention;

FIG. 10 is a function diagram of a process for selecting vendors to invite to submit bids in response to RFPs in accordance with the principles of the present invention;

FIG. 11 is a function diagram of a process for a vendor to reserve a bid slot regarding an RFP in accordance with the principles of the present invention;

FIG. 12 is a function diagram of a process for submitting a bid in response to an RFP in accordance with the principles of the present invention;

FIG. 13 is a function diagram of a process for preparing a bid summary and report in accordance with the principles of the present invention;

FIG. 14 is a function diagram of a job award process in accordance with the principles of the present invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The system and process of the invention may be specialized such that they are specific to real estate managers or facility managers, including nonprofits and entities servicing them. However, portions of the processes may be used separately or in various combinations. Further, the system of generating standardized, or structured, RFPs and SOWs, obtaining responses and generating a composite report for comparison of the responses may be applied to other industries and fields in which RFPs, or any description of a needed person, project or service, and responses thereto may be used. Thus any solicitor of RFPs, defined rather broadly here, may utilize aspects of the invention.

A system in accordance with the invention may create line items, or a RFP solicitor may create line items, each requiring a response within any bids submitted in response. Optionally the system may include processes, for example a software wizard, to assist in the creation of line items by a solicitor of RFPs. Line items may be created manually and may divide a Scope Of Work (SOW) incorporated into a particular RFP into separate line items. The solicitor, for example a property manager, may optionally require a vendor to assign a line item price to any or all aspects of an SOW. A proposal form based on the line-item concept may ensure that all vendors may be bidding to the same specifications. The bid contained in the proposal may be created manually and/or with the assistance of a software wizard to assure that the proposals may be compared one to another accurately. For example, industry-specific wizards may guide an RFP solicitor through the RFP and SOW creation processes and assist in creating line items through a series of questions and selections and fill-in fields that help the user to define the SOW. The wizard may facilitate populating multiple line items so that each line item may require a price. The SOW generated or a derivative thereof may be used as a template which vendors may then populate in order to prepare proposals. The vendor proposal process, with the assistance of one or more wizards, may simplify the submissions system. It also may ensure that a proposal is fully and accurately responsive to an RFP and SOW.

A Proposal Report may be generated using some or all of the items included in an RFP and/or an SOW, along with the vendor proposals itemized in a manner that facilitates easy comparison and eliminates or reduces vague, ambiguous, nebulous or obfuscating language ubiquitous in the bidding processes of many industries.

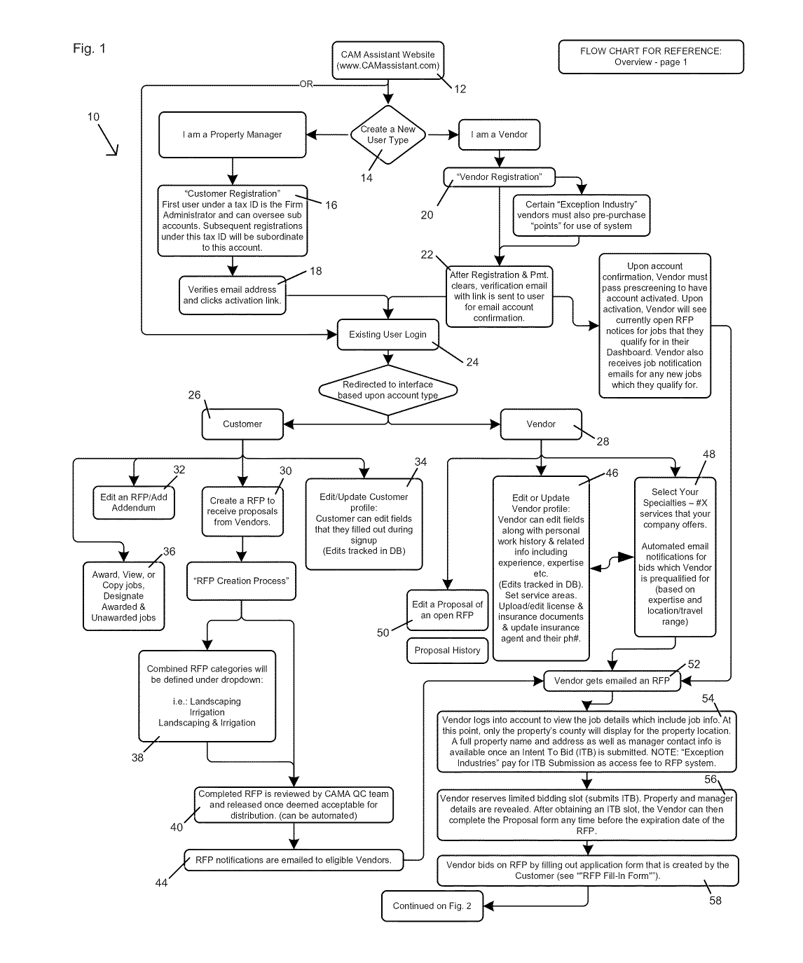

Referring now to the Figures, FIGS. 1-3 provide a flowchart exemplifying an embodiment of a system 10 in accordance with the principles of the invention. In this embodiment, a solicitor, referred to in this embodiment as a customer, may access aspects of the invention by means of a website or similar portal 12. If not already registered, a user may choose 14 whether he or she wishes to register as a vendor or a property manager. When a new user chooses to register as a solicitor, at this case, a property manager, he may be asked to provide information at 16 relating to him, his company, properties managed and the like once a property manager's information is verified 18, he may then log in at 24. Alternatively, where a new user is a vendor, he or she may provide information during the vendor registration processed 12. As with property managers, a vendor may be verified and then may login as an existing user at 24.

When an existing user logs in, the system in accordance with aspects of the invention may redirect the user to the customer interfaces 26 or the vendor interfaces 28. A customer may then, using the system 10, create a structured RFP 30, edit or update an existing RFP 32, make changes to the customer profile 34, or may view the status of RFPs for which bids are being accepted 36, including awarding jobs to various vendors, updating information about the property, sealing, resealing or unsealing different submissions, changing deadlines to respond, and the like. When a customer creates a new RFP 30, the system may guide the customer through the process of creating a structured RFP at 38. A structured RFP provides a methodical sundering or parsing of a project into component parts. This facilitates expression of an RFP as a series of line items. The RFP creation process at 38 may include the use of a software wizard. It may also allow a customer to permit only a finite number of possible answers to be provided in response to each line item of an RFP.

Once a structured RFP has been created, the system may include an automated review of the completed RFP or optionally may provide for a 3rd party or entity to review the RFP for completeness and accuracy at 40. Once a structured RFP has been verified as complete at 40, vendors may be notified 44. Which vendors may be notified may be determined by the solicitor, or an operator of the system, or may be automatically determined by the system. A solicitor, or customer, may identify preferred vendors that may be notified prior to notification of all vendors. The solicitor may also block selected vendors from viewing its RFPs. Optionally, vendors may be selected according to identified fields of an industry, location or by other factors.

Where a user has logged in as a vendor, the system may redirect it to the vendor management, portions of the system. A vendor may then edit or update his, her or its profile 46, including submissions of licenses, accreditations and other qualifications. A vendor may also choose to designate itself as having various specialties or qualifications at 48. Vendors often desire to include in a bid submission information or explanations of its qualifications in order to appeal to a solicitor who has issued an RFP. The structured RFPs of the system remove many opportunities for a vendor to editorialize. Thus, it may be desirable to include a step 48, where vendors may tout their specialties. A vendor may also submit proposals and/or edit existing proposals at 50.

Once a vendor has been notified of RFPs for which it qualifies at 52, the vendor may access the structured RFP, determine whether it wishes to submit a proposal and investigate the details of the RFP at 54. Optionally, some vendors may be granted early access to a recently prepared structured RFP and may therefore reserve a bidding spot 56. Prior to a general release of the RFP. Which vendors may be granted early access to a recently prepared structured RFP may depend upon any number of factors including whether the vendor is preferred, whether the customer has specifically selected the vendor for early notice, or any other suitable factor.

A customer may limit the number of vendors that may submit an RFP, or may accept as many proposals as desired. When a vendor selects an RFP to respond to with a proposal at 56, the vendor may be directed to a structured proposal form, such as for example a software wizard or the like. An aspect of the invention provides that in responding to an RFP, the vendor must respond to every item in the structured RFP using one of the possible, sometimes limited, answers, as created when a customer prepared a structured RFP. As a result, a structured proposal may be provided responding directly to an RFP, line by line. These proposals may be submitted at 60. If a limited time period has been set by a customer for a particular structured bid, vendors may continue to submit proposals until that time period ends 62. At that time, an aspect of the invention may prepare a comparison charts providing an “apples to apples” comparison, line by line, of the structured proposals submitted by vendors at 64. A customer may then select a proposal at 66. A system of the invention may include an aspect, such as software, which may then automatically notify the vendors whether their bids were selected. When a winning vendor accepts a project at 70, the system of the invention may automatically generate an invoice to be supplied to the vendor for payment to the system or the operator of the system in accordance with the invention. Losing vendors may also receive at 72, a report showing the highest and lowest bids made in response to the RFP or other information that may be useful to a vendor. Similarly, the customer may also be notified at 74. A system of the invention may also require payment to the 3rd party at 76 within a certain time frame, or the transaction may be terminated. Optionally, a third party operating a system in accordance with the principles of the invention may serve as an escrow agent for the customer and vendor.

It may also be desirable to provide a survey form at 78 to customers and/or vendors in order to provide feedback to the customers, vendors, and to a 3rd party operating the system. If the customer or vendor is not pleased with the outcome, he may be asked to participate in quality control or quality assurance processes as shown at 80. Input provided by the survey may be used to rate vendors and customers 82 so that in the future other vendors and customers may benefit from the information.

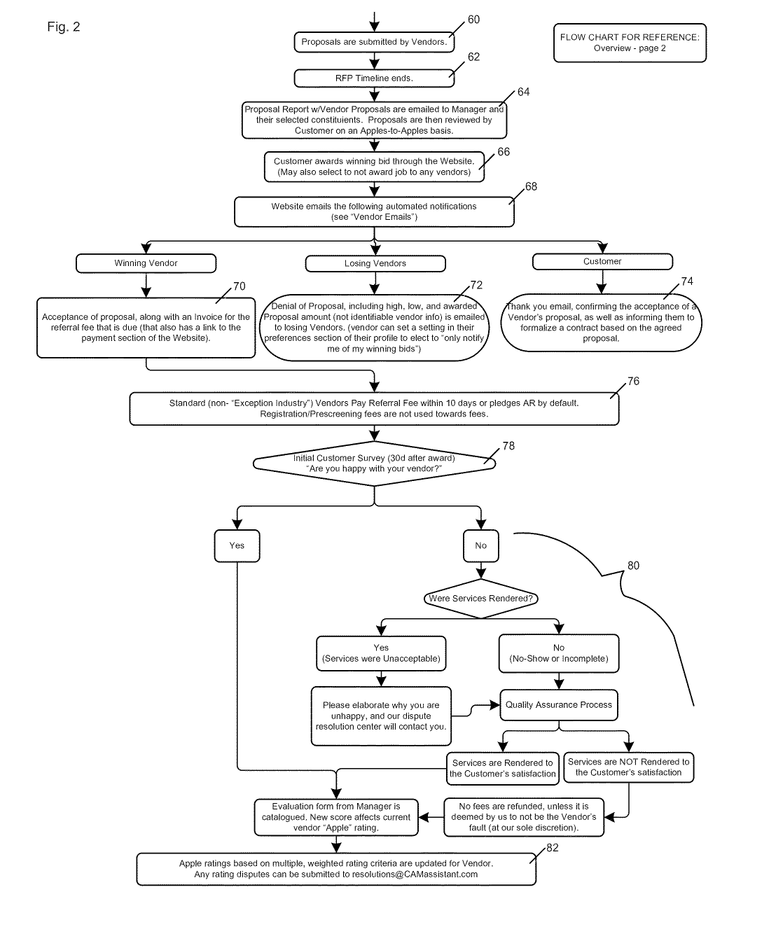

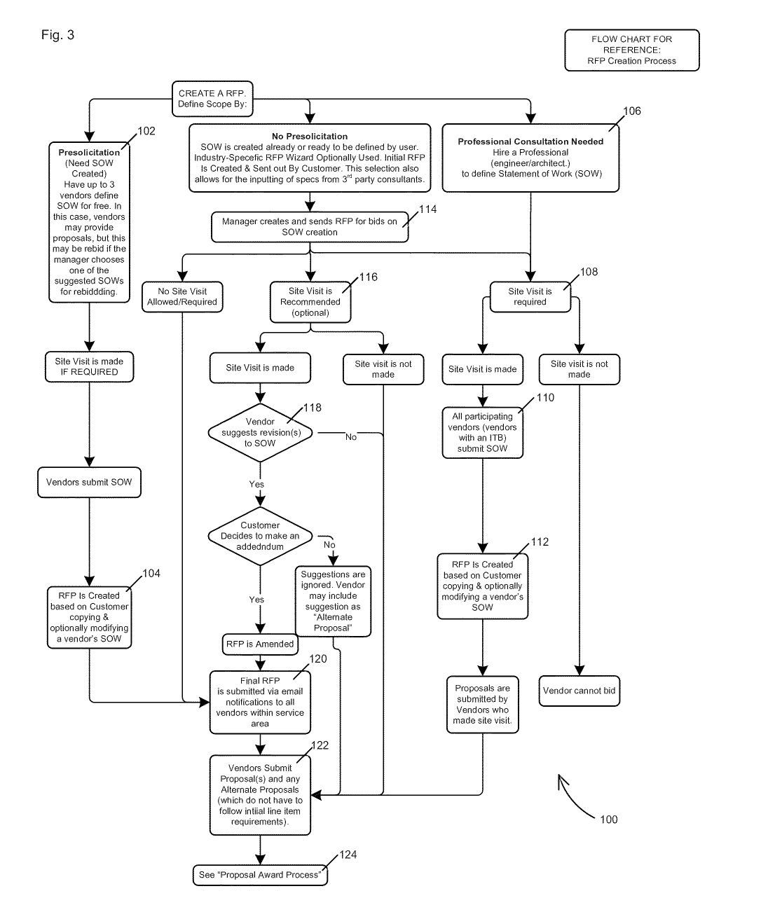

FIG. 3 shows a structured RFP creation process 100 in accordance with the principles of the invention in greater detail. A customer may pre-solicit bids at 102 from selected vendors in order to create a Statement Of Work (SOW). SOWs from the pre-solicitation bid may be used to assist a customer in creating a structured RFP at 104. For some projects, it may be necessary to communicate with a professional consultant as shown at 106. This consultation may be used to prepare an SOW. Often, the consultant may also be a vendor. Once a customer has chosen vendors to act as consultants, a consultant/vendor may visit the property at 108 and then submit an SOW at 110. The SOW's obtained through this process may then be used to form a structured RFP at 112. Alternatively, no pre-solicitation or consultation may be used and a customer may prepare an RFP, ab initio at 114. A customer may choose whether or not to visit a site prior to creating an ab initio structured RFP at 116. A customer may optionally request input from one or more vendors regarding an SOW at 118. The final version of the RFP may then be used at 122 to determine which vendors may be selected for submitting bids, and whether there are any preferred bidders. As shown in FIGS. 1-2 above, vendors may then submit proposals to the customer 122 and finally the customer selects a winning bid at 124.

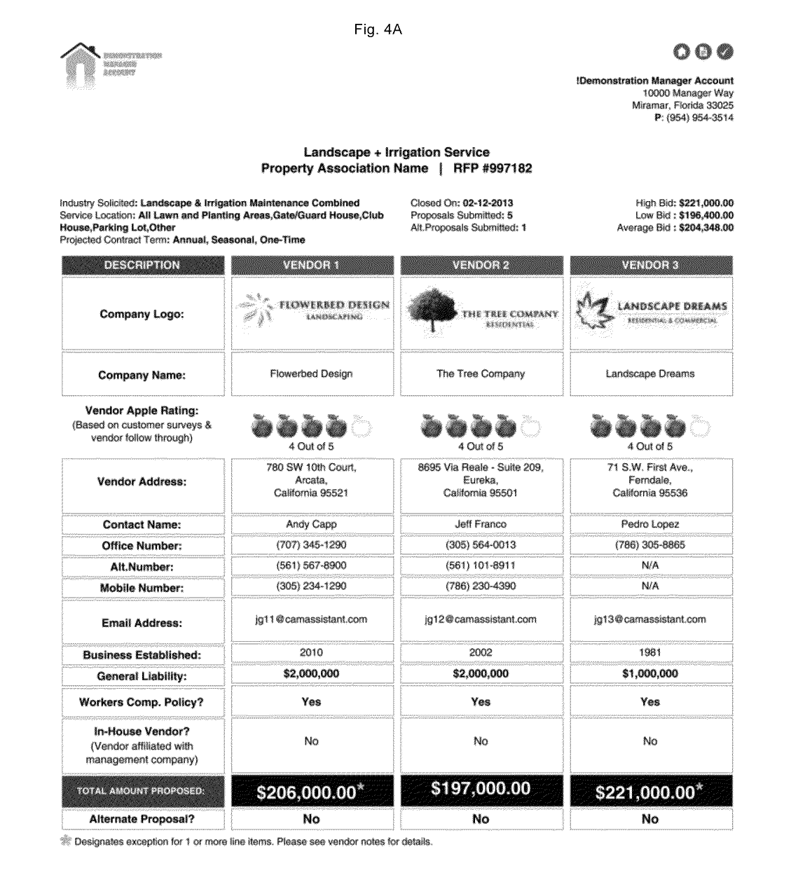

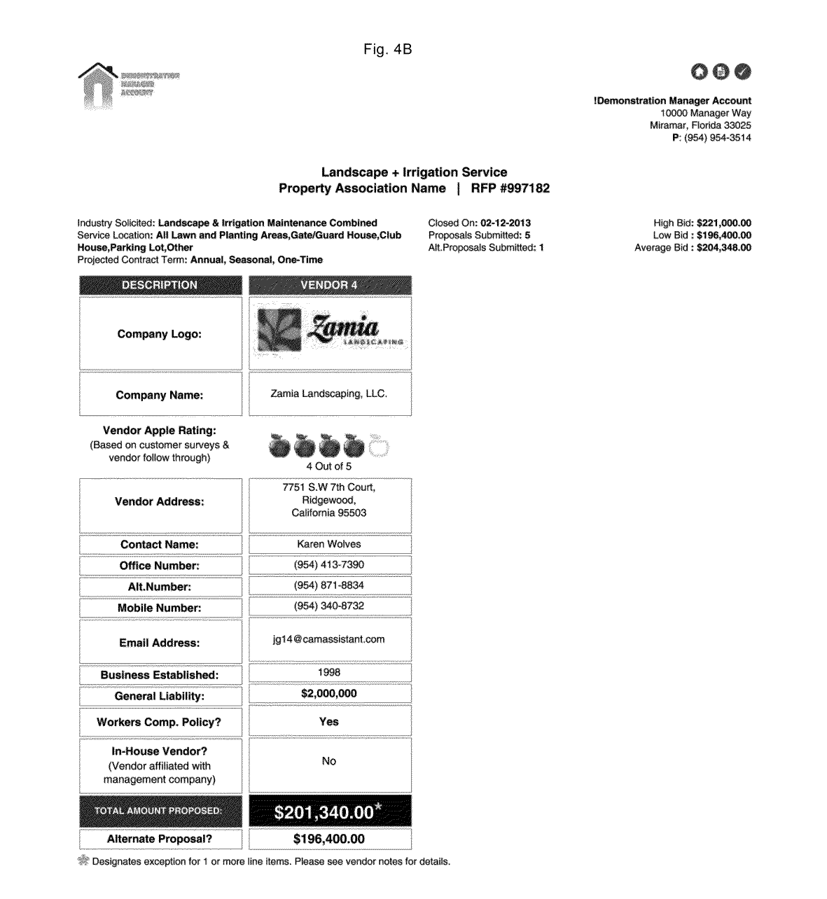

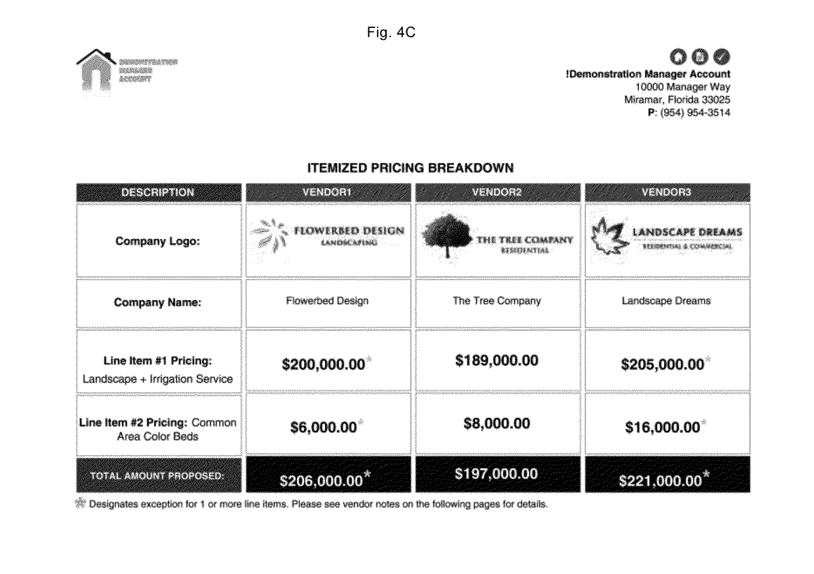

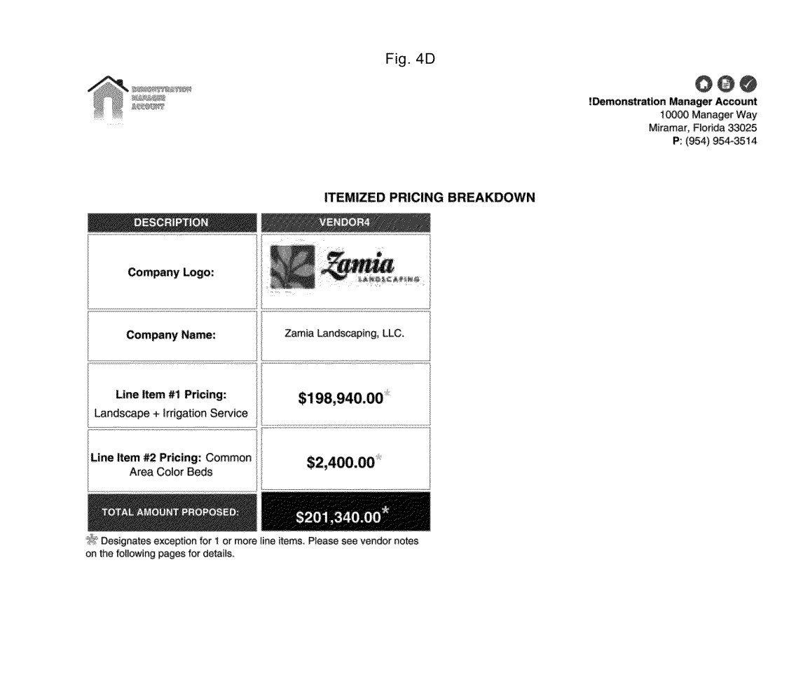

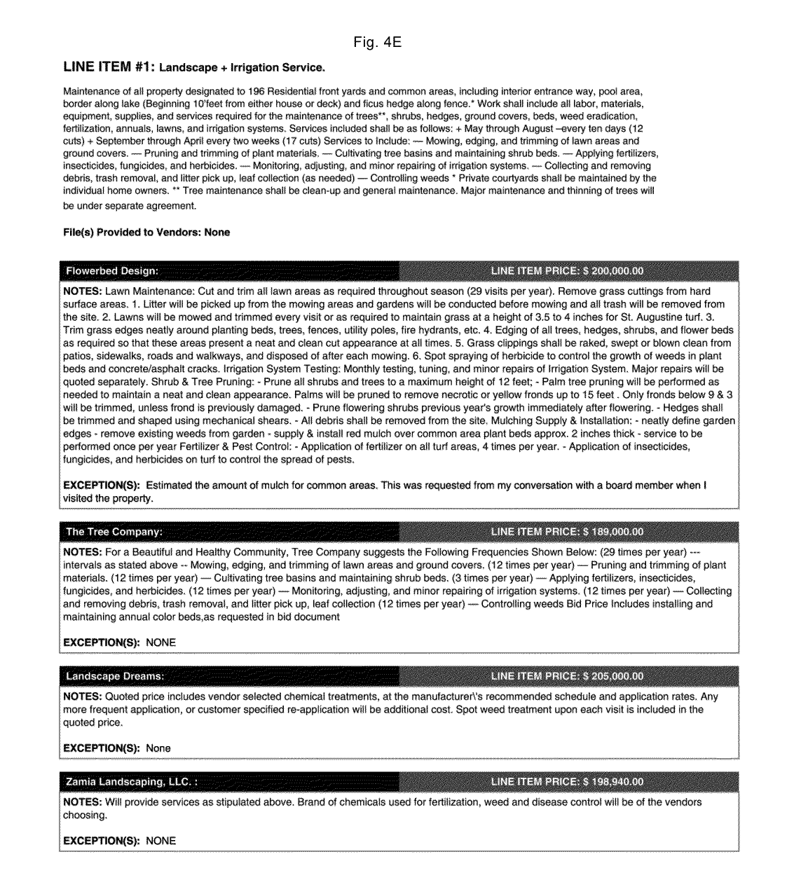

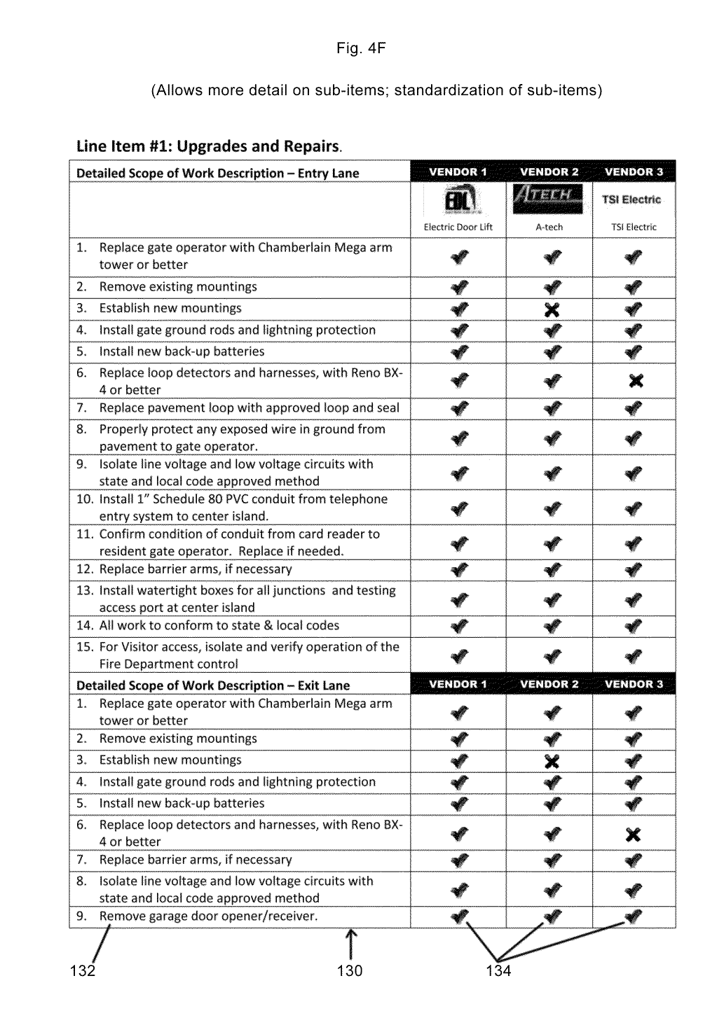

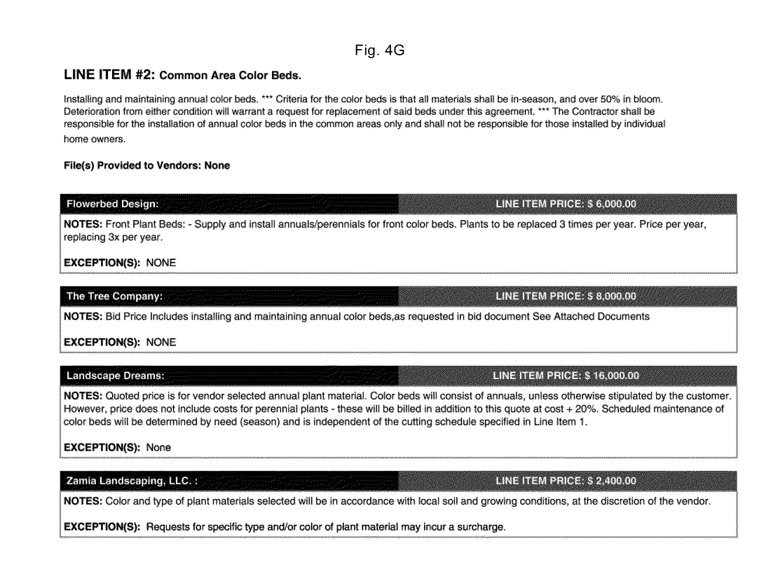

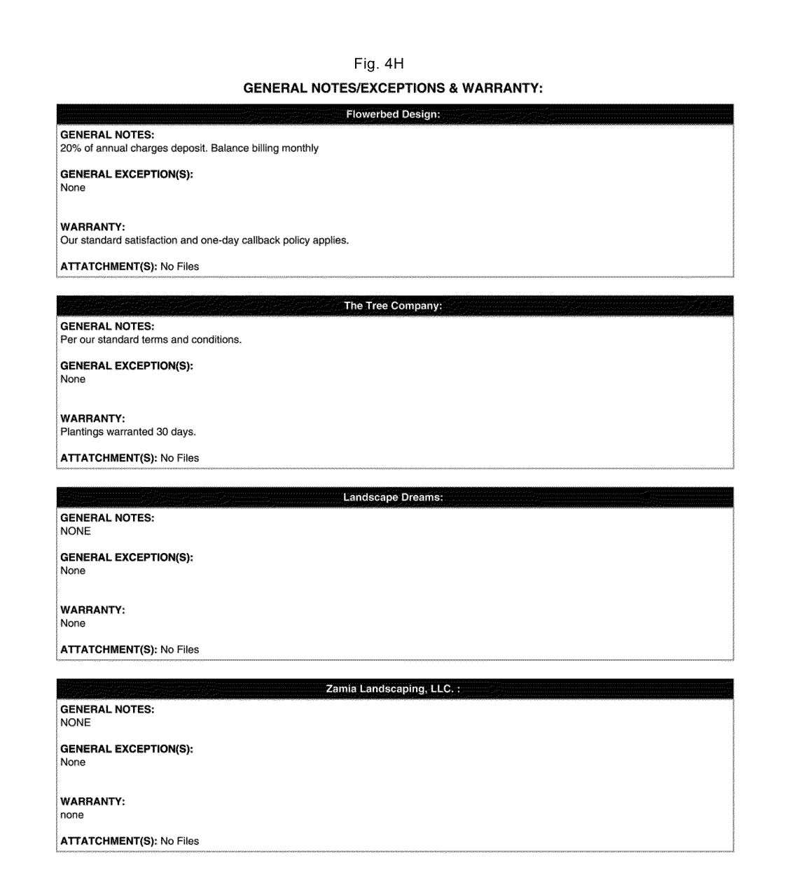

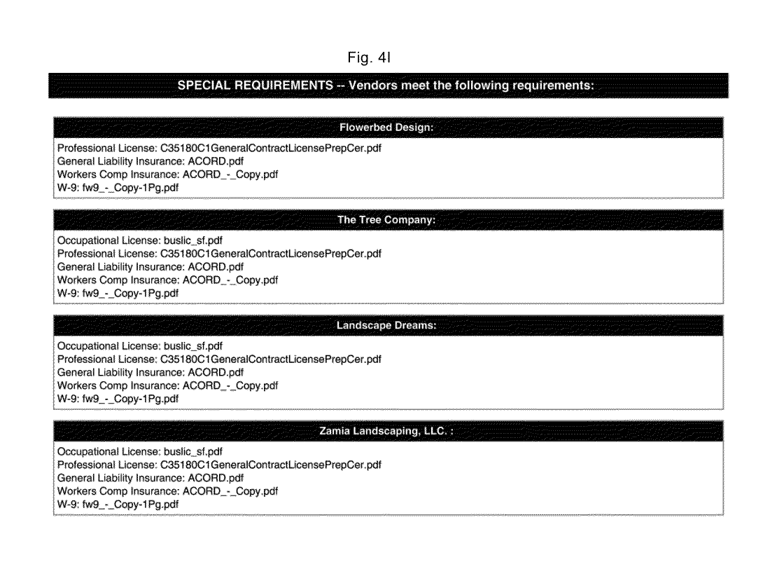

FIGS. 4A-4I show an exemplary proposal report which may provide a line by line comparison of proposals by different vendors as shown in FIGS. 4A-4D. A comparison chart 130, shown in FIG. 4F may also be included. Line items of a structured RFP may be displayed in a first column 132. Columns 134 may display the responses provided and the structured proposals from different vendors. This may allow the customer to quickly and easily compare the different structured proposals provided in order to facilitate the choosing of a vendor.

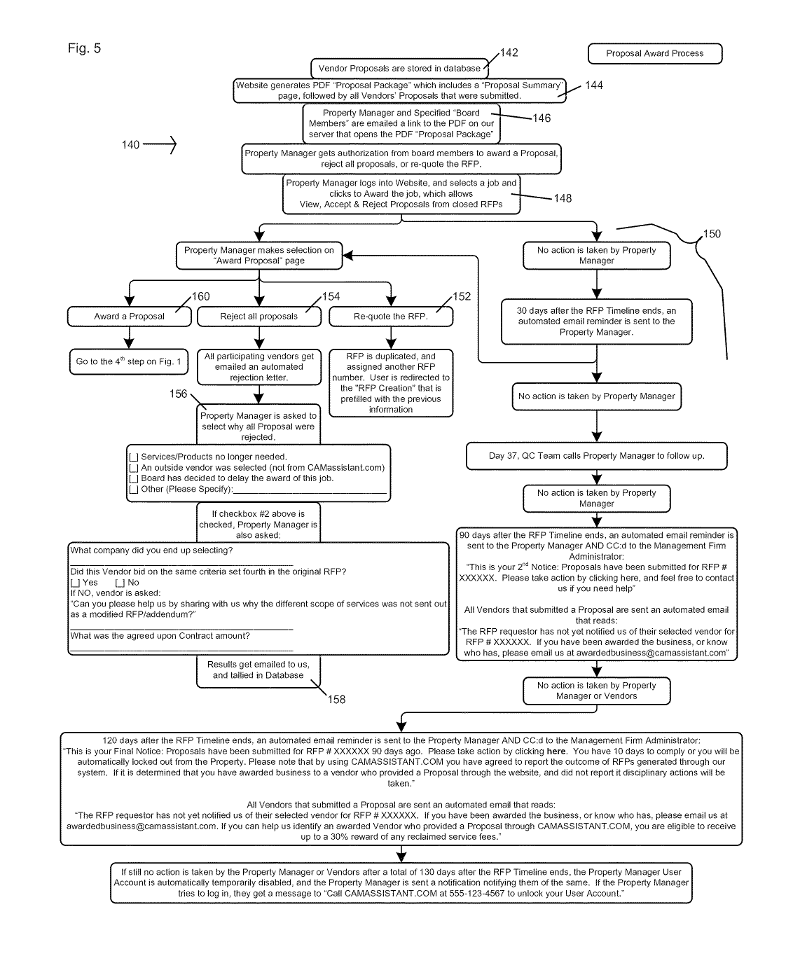

FIG. 5 shows a flowchart of the proposal award process 140. Proposals may be submitted 142 and then used to provide a proposal package at 144. The proposal package may include a comparison charts as well as additional details and specifics of each individual proposal. The customer may then be provided the proposal package at 146 and then may select a proposal at 148. If a customer does not choose any of the proposals, the system may send reminders over a given time frame 150. If no proposals are satisfactory, a customer may requote the RFP at 152. Optionally, the customer may decide to reject all proposals at 154. Optionally, upon rejection of all proposals, a customer may be asked why no proposals were selected at 156. The results of this inquiry may be provided to an operator of the system at 158. If a proposal is accepted at 160, notification of the acceptant may be sent to the customer and vendors.

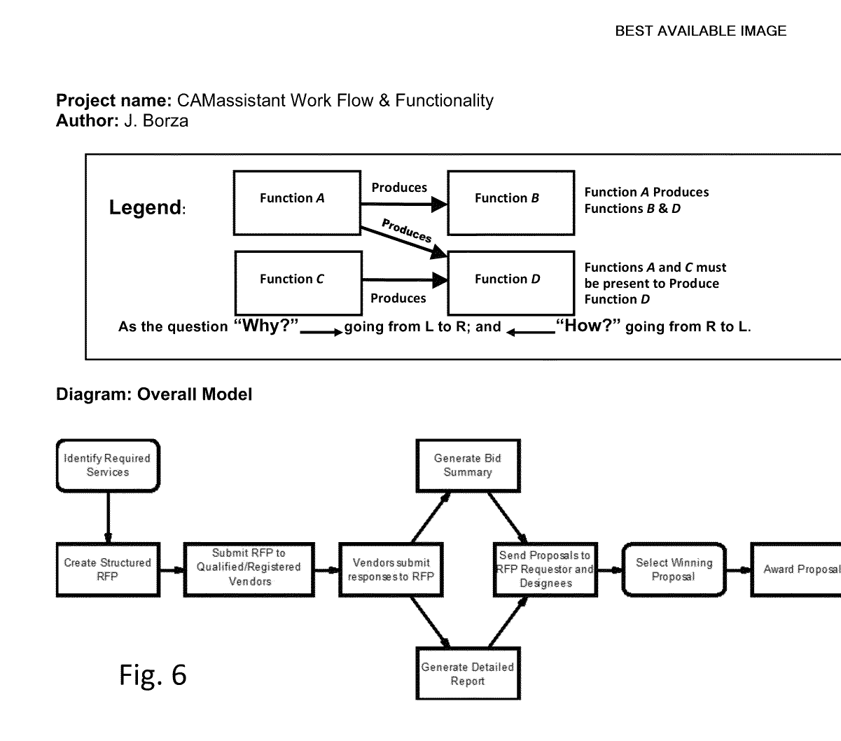

FIG. 6 shows a function diagram of an overall model in accordance with the principles of the present invention. The process begins when a solicitor, such as an owner, property manager or other seeker of goods or services identifies a required service or product. Next, a structured RFP is created and submitted. Vendors may then submit proposals, including bids, according to the structure of the structured RFP. A bid summary and/or a detailed report such as a comparison chart may be generated using submitted proposals or bids. The summary and/or report may then be provided to the solicitor who created the structured RFP allowing it to make a better informed decision in selecting a vendor and awarding a contract.

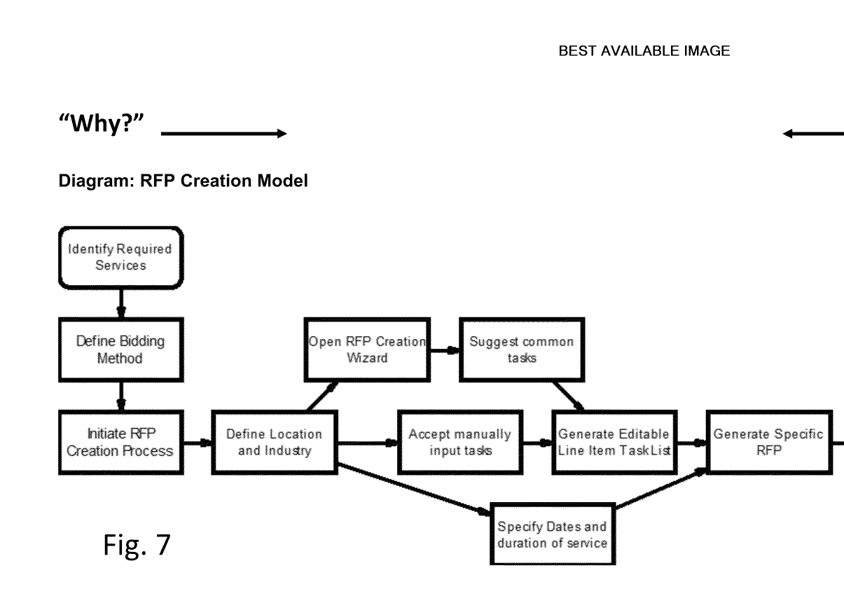

FIG. 7 provides an exemplary model for creation of an RFP that may be used in the process of FIG. 6.

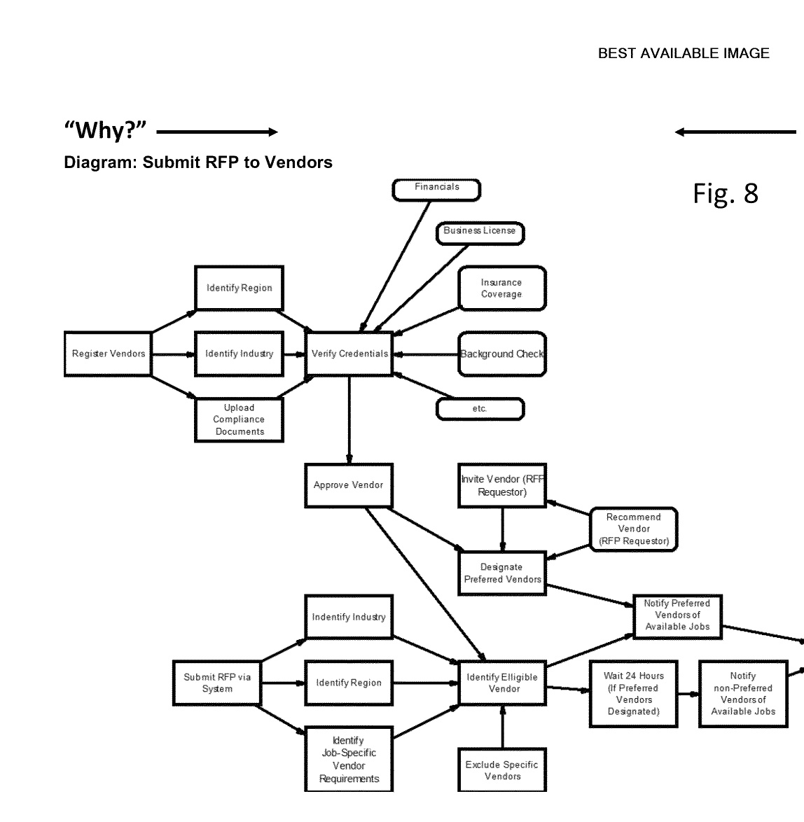

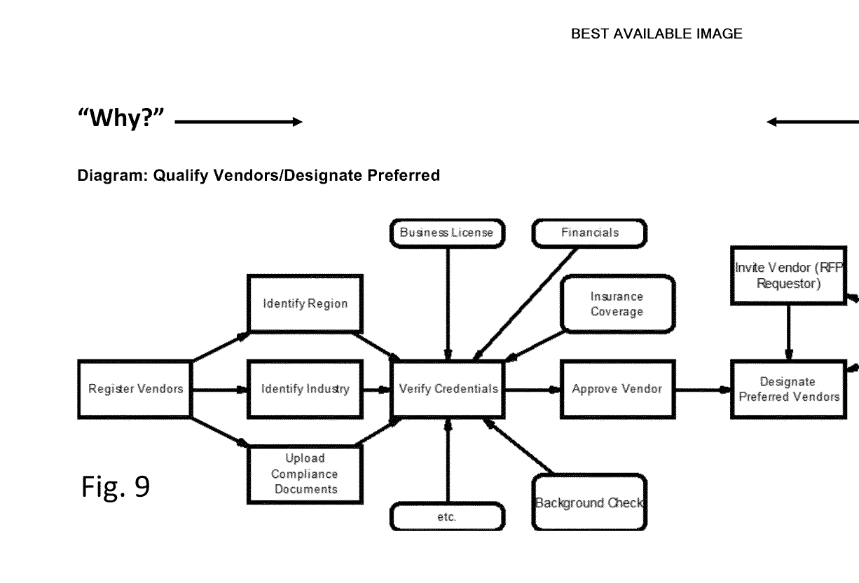

FIG. 8 shows a function diagram illustrating an exemplary process for registering vendors, verifying a vendor's credentials and incorporating vendors in to the process of FIG. 6. Vendors may supply information such as accreditation, business, professional or other licenses, proof of insurance and other information that solicitors may find pertinent in selecting which vendor or proposal to select. FIG. 9 shows a function diagram illustrating a vendor registration and credential verification process also in accordance with the principles of the present invention.

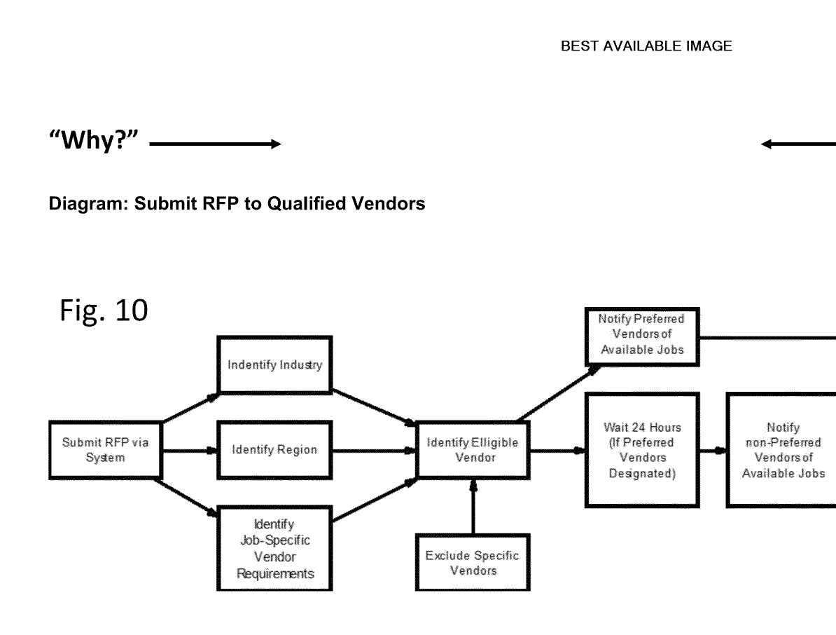

FIG. 10 shows function diagram of a process for identifying vendors to invite to submit bids in response to a particular RFP and an option to provide a 24 hour or other waiting period during which preferred vendors may be allowed to consider whether they wish to reserve a spot among a finite number of allowed proposals in response to an RFP. After preferred vendors are given an opportunity to elect to participate in the RFP process, the RFP may be released to any other suitable vendors. FIG. 11 shows function diagram of a process by which a vendor may receive notification of an RFP and decide to compete for the job.

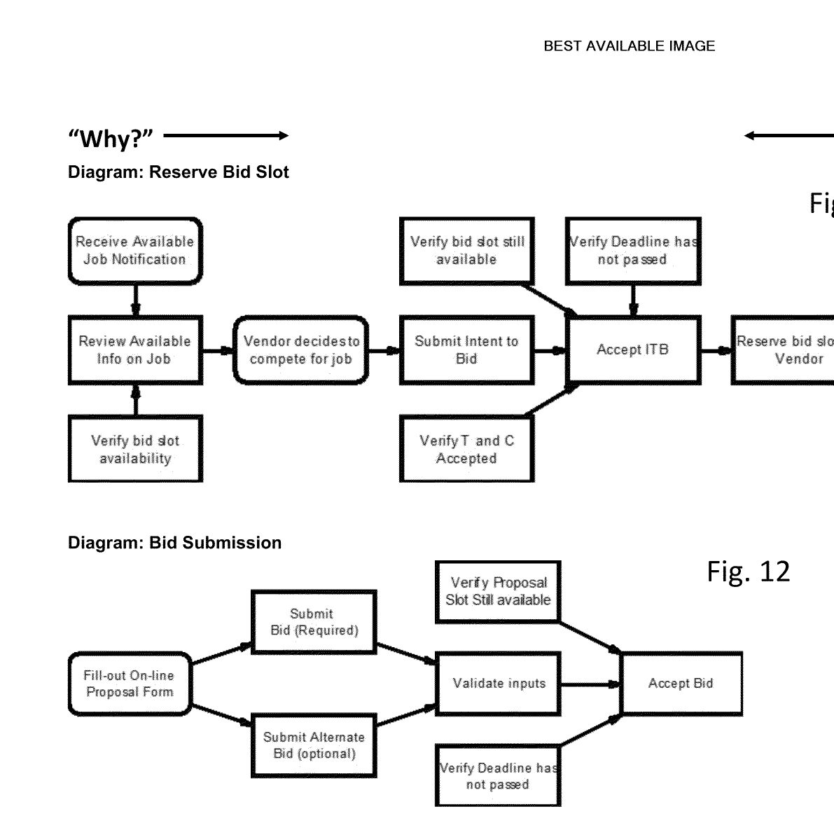

FIG. 12 shows function diagram of a process by which a vendor may submit a bid in response to an RFP upon deciding to compete for a job.

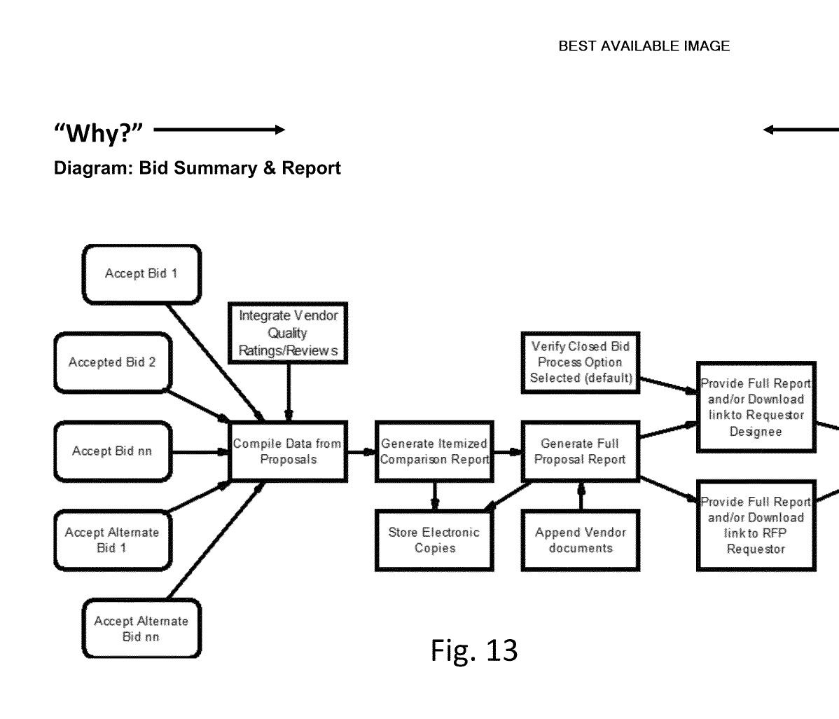

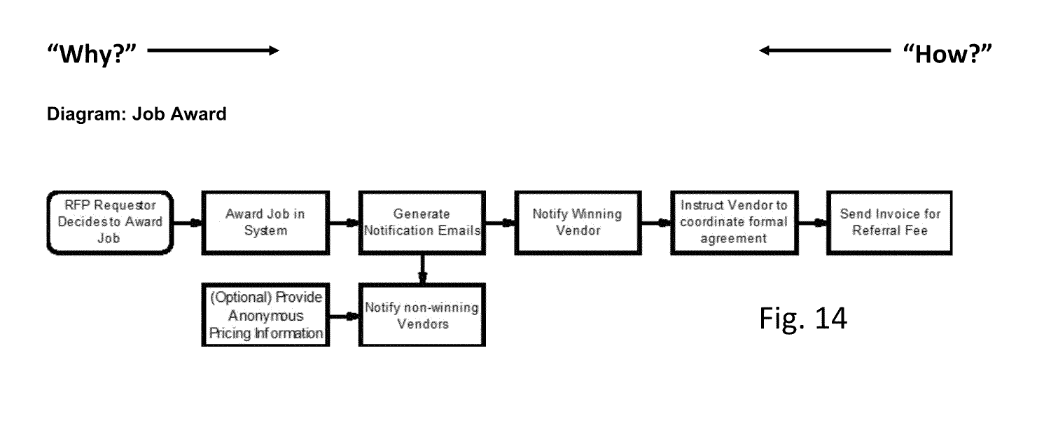

FIG. 13 shows function diagram of a process for preparing a bid summary and report from several bids to consolidate the bid information and providing it to owners, HOA members, property managers or the like. Finally, FIG. 14 shows a process by which an HOA BoD, owner or the like may award a job to a vendor.

After registering, solicitors, in this case managers or authorized users, may log in and create RFPs, preferably online at a website or similar portal. During creation of the RFP, a manager may define a project and specify the requirements of a project either manually or via an industry-specific wizard that may facilitate RFP and/or SOW creation. Additionally, RFPs may be prepared to hire a professional (for example an engineer or architect) to assist or perform specific projects.

Once an RFP is ready, it may be submitted to potential vendors via an online or other system. Submitted RFPs may optionally be reviewed for quality assurance by a third party operator of the system that may manage the RFP creation system, before being released to eligible vendors. Email or other notifications may then be sent to the vendors upon the approval and/or distribution of their RFP. Vendors may then be notified of the availability of the RFP. Which vendors are notified and solicited for bidding may be selected by the solicitor, authorized users and/or a third party operator of the system, and may also optionally be determined by factors such as for example the industry being solicited and the location of the property. This selection process may be attenuated using a vendor rating system, wherein vendors may be rated according to various criteria. Managers may also designate preferred vendors, excluded vendors that are not permitted to receive solicitations or submit bids and other designations or conditions on vendors and the content of proposals. The manger may optionally specify maximum and minimum numbers of proposals to receive and a proposal submission deadline. There may also be an option to set additional requirements for vendors such as licensure, insurance or other requirements such as number of years in business or quality rating/score.

Vendors may respond within the time frame specified, or within a predetermined time prior to a deadline, in order to allow quality assurance, quality control or other functions to be performed by a third party system operator. Optionally, a solicitor may extend a time frame, allow vendors to submit proposals after the time frame, or eliminate the time frame. Submitted proper and timely proposals may be made available to the soliciting property manager. Aspects of the invention may use a website or other online system and may create a paperless, fast, accurate bidding process that may be confidential. Optionally a solicitor may be able to review proposals only after the time period for submissions has ended, known as a “sealed bidding/proposals,” or may review proposals as they are provided, known as “open bidding.” Optionally a solicitor may request sealed proposals but later choose to open them prior to the expiration of a time period. Similarly, the opening and the closing of the bidding process may be modified at any time by the solicitor.

Submitted proposals may be combined into a unique report that shows a line-by-line item comparison matrix of the vendors' proposals such as for example the comparison chart of FIG. 4. Often proposals may be reviewed and evaluated by a group of persons, such as for example a community association board. Often, these boards are not professional businesspersons and an easily reviewable report comparing proposals may be highly beneficial for facilitating selection of a particular best or most acceptable proposal and agreement among a group. The proposal report may contain all of the proposals, insurance, W9 forms, licenses, ratings, other required documents and the like. A report may include an at-a-glance summary of the vendors that submitted proposals, their overall prices, and any alternative proposal pricing provided. The report may also include a breakdown of the high, low and average bid. The report may optionally include a rating assigned to each vendor. The rating system (based, e.g. on prescreening and property manager surveys), may comprise ratings based on price, quality, dependability and the like. A proposal report optionally may be personalized or branded with a property management company's logo or the logo of the third party operator. The remainder of the report may provide item details, pricing, additional information, documents, comments and any exclusions, exceptions, and provisions provided by the vendors.

If no suitable proposal is submitted, a property manager may close out the RFP and optionally revise the project and submit a new RFP.

Solicitors such as management companies may invite their own vendors to utilize aspects of the invention in order to access RFPs. Solicitors may optionally have the ability to categorize vendors. A vendor may be assigned a “preferred,” “in-house,” “excluded” or other vendor status by a solicitor, or any other designations, system of ranking or rating of vendors may be used. Some vendors, such as for example those ranked “preferred” or “in-house,” may be given an opportunity to submit proposals prior to release of the RFP to other vendors.

Compliance documents may optionally be uploaded, using for example a system as shown in FIG. 8 and approved to enable eligibility of vendors. Vendors may directly upload files or have a 3^{rd} party do it on their behalf. Compliance documents uploaded may be specific to the company/entity uploading the files and may include, but are not limited to, IRS form W-9, General Liability and other insurance documents, professional, occupational and other license information, and any professional documents, designations and the like. Date ranges of coverages and document expiration dates may be verified and validated.

Each approved document may be cross-referenced based on the eligibility requirements of a job. This allows an RFP solicitor to optionally set eligibility requirements based on current uploaded credentials and/or any information contained therein, including but not limited to, for example, insurance coverage amounts. Once a vendor's required documents are approved and/or verified (and current), they may become eligible to receive RFPs and submit proposals within their service area and within their industry/industries. If at any point a compliance document becomes unapproved, expired, or otherwise ineligible, a notification may be sent to the vendor. This notification may be sent in advance when applicable in an effort to encourage a vendor to maintain current, valid documents on file.

Property managers may optionally sort the order of eligible vendors to determine the order in which RFP notifications are sent for a given project or job. This may allow property managers to view a list of current eligible vendors before generating and/or submitting an RFP. They may then sort the vendors by placing their preferred vendors on top of the list, and less desirable vendors toward the bottom of the list. This list may determine the priority in which the vendors are notified about the RFP. As an exemplary embodiment of an aspect of the invention, upon a third party operator's approval of the proposal (wherein quality assurance, quality control and other functions may be performed), a single vendor at a time may be notified via email, text message, regular mail or the like, at regular time intervals, for example every 24 hours. If a vendor does not respond within the preset time interval, then the next vendor on the list or other satisfactory vendor may be notified. This process may be repeated until a desired number of vendors have been identified to respond to an RFP.

In an alternative embodiment of aspects of the invention, a predetermined plural number of vendors from a list may be notified over a predefined interval of time. If all vendors do not reserve bidding slots before expiration of a time period, then additional vendors may be invited to submit proposals. This may limit vendor frustration once bidding slots are all reserved because not all eligible vendors are notified at once. Which vendors are notified and in what order may be determined by a variety of means, including sorting according to property manager ranking, randomly, according to ranking by a third party operator, or other methods. When an RFP solicitor marks a project as awarded (i.e. selects a winning proposal), notifications may be automatically sent to all participating vendors. The awarded vendor may be sent an award notification. Non-awarded vendors may similarly be sent a notification that they have not been awarded. Either notification may optionally include information of the high, low and awarded bid amounts submitted for that RFP.

When uploading documents to an RFP, the documents may optionally be uploaded into a folder for a specific property serviced. Therefore if a property changes ownership (or managing control), the history of the property may be portable along with the documents and proposal reports. In order to maintain such a history, a property manager may not be permitted to delete documents in property folders. This chain of custody may allow for a clean changeover of property and may facilitate sales and other transfers of properties.

Vendors may undergo background (criminal, financial and the like) screening. Vendors may then log in to the website and upload various documents (e.g. general liability insurance & W-9). In order to meet any increased eligibility requirements of an RFP, vendors may be encouraged to upload additional licensure and insurance documentation. Wizards and/or electronic based tutorials may be used to assist vendors through the process. A third party managing the system of the invention may provide verification of this information.

In one embodiment, detailed in FIG. 10, RFP notifications may be sent to all eligible vendors within the relevant industry and service area. Notification may for example be comprised of an email having a link that directs a vendor to a secure page on a website that displays an RFP and/or an SOW. In order for a vendor to create and submit a proposal, they may be required to reserve one of a limited proposal slots by confirming an “intent to bid” within a preset time period. By confirming an intent to bid, vendors may agree that they have fully read and understand the RFP, and agree to furnish a proposal. Once an intent to bid slot is successfully reserved by a vendor, the available property and contact information may become visible to the vendor. The vendor then may have until the closing of the RFP to submit a proposal, and one or more alternate proposals.

In one aspect, a system may provide that a vendor complete a proposal form, for example on a website using a wizard. This may allow convenient fill-in fields for easy proposal creation on a line-item-by-line-item basis. Vendors may attach documents (including warranties, product sheets, and any other pertinent information). An online system may also allow for saving a proposal to complete at a later date. Thus the saved proposal may be modified at a later time. Optionally, a vendor may also submit one or more alternative proposals. This may allow for any alternate solutions and pricing that a vendor may elect to offer. If there are any changes to an RFP after it is issued, the vendor may be automatically notified of the change, and given an opportunity to modify their proposal(s).

Once a manager reports the status of a RFP award, automated notifications may be sent to participating vendors. The awarded vendor may receive a notification with any additional details of the project, contact instructions and the like. Non-awarded vendors may also be sent an email, optionally providing anonymous high, low, and awarded dollar amounts of the proposals.

An awarded vendor may also be sent an invoice for a referral fee collected by a third party operator of a system used for various aspects of the invention. This referral fee may be based on a sliding-scale percentage of the cumulative projects or jobs awarded to a vendor over a preset time period, for example within a given month. Optionally, a vendor may pledge receivables to the operator. By pledging receivables, a vendor referral fee may be paid as an obligation superior to payment for the project or job.

A property manager, owner or the like may also use aspects of the invention to seek employees. Available persons may “apply” by becoming approved vendors. Similarly, staffing agencies may become approved vendors. The property manager, owner or the like may then prepare a job description as an RFP which will then be sent to the appropriate vendors. Persons or staffing agencies may choose to respond, thereby providing a list of potential employees as a summary just as vendors apply for particular projects.

The invention may also be further modified to suit employers and job seekers in any industry. An employer may use the system described herein to prepare an RFP comprising a job description and educational and experience requirements for an employee to fill. Individuals seeking employment, or staffing agencies may register as vendors. Different vendors may be preferred for different job descriptions. Vendors may be notified once an RFP is placed and given the opportunity to “bid” on the employment opportunity with salary requirements, resumes, C.V.s, cover letters and the like. Such a system provides more control over the employment process to the employer, allowing selectivity in who responds to a job posting. This may prevent an employer from being inundated with copious applications, many of which are irrelevant to the position available and serve only to complicate the employment process.

In one aspect of the invention, a solicitor may define a plurality of fields for which the RFP request specific answers. The solicitor may similarly define and/or limit the numbers were types of responses available to a vendor in preparing a proposal. In current RFP systems, vendors do not always provide information as clearly or directly as may be desired by a solicitor. By providing a solicitor the means to define questions and answers to be included in all bids, the system allows solicitors to more easily discern the distinctions between various proposals. That is, the invention may facilitate “apples to apples” comparisons between proposals in response to an RFP. The invention may allow itemized, line by line, “apples to apples” comparison. Thus, one aspect of the invention provides simplicity and clarity, not otherwise readily obtained in these processes. Often, a solicitor issues an RFP and vendors may respond howsoever they prefer. Thus proposals may include language, terms or descriptions that may be ambiguous and not conducive to an item by item “apples to apples” comparison.

It may also be desirable for an aspect of the invention to allow itemized bidding in response to an RFP. Thus, RFPs may request specific bids on various line items throughout an RFP. This may add to clarity. Optionally, this may also facilitate a 2nd tier incorporated into the invention. That is, vendors themselves may function as solicitors, submitting their own RFPs to other vendors, such as sub contractors, for particular line items or subparts to an RFP for which the vendor wishes to submit a proposal in response to. A 2nd tier may perform in a manner similar to the first tier and may optionally be incorporated into a website or other online system. Those skilled in the art will appreciate that such a system may simplify and accelerate the RFP and bid submittal system and improve accuracy of communications within the process.

In addition, an aspect of the invention may include updating a solicitor in real time regarding the bid process. Thus, a solicitor may monitor which vendors do or wish to submit proposals in response to an RFP. Optionally, a solicitor may be provided vendor information so that a solicitor may communicate directly with a vendor regarding any questions or details relating to an RFP. As with systems currently used, a solicitor typically may have access to all of the information regarding a vendor and its proposal, but a solicitor may not typically share much or any information with other responsive vendors regarding other proposals. Optionally, the entire process may be transparent.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the invention upon which this disclosure is based, may readily be used as a basis for the designing of other structures, methods and systems for carrying out the several purposes of the present invention. It is important, therefore, that the claims be regarded as including such equivalent systems and methods insofar as they do not depart from the spirit and scope of the present invention.

1. A computer-assisted system and method for acquiring bids for products and services from vendors comprising:
providing a computer including memory, processor, user interface, visual output, and having internet access;
creating and storing in said computer memory a structured RFP having a SOW;
distributing from the computer memory, over the internet, the RFP to registered and qualified vendors;
accepting in the computer memory, from an internet transmission, proposals from at least one of such vendors based upon the RFP and SOW provided;
storing the accepted proposals in the computer memory in an easily reviewed, itemized apples-to-apples summary; and, creating with software and providing to a computer user the summary and detailed proposals, with vendor compliance documents in response to the RFP.

2. A system as set forth in claim 1 whereby vendors who submitted proposals can be automatically notified over the internet of an award of business or a rejection of submitted proposals.

3. A system as in claim 1 which stores RFP, SOW's, vendor proposals, vendor submitted compliance documents and other property related files electronically in packages.

4. A system and method by which Service requestors (property managers) are assisted in the creation and dissemination of statements of work (SOW's) and requests for proposals (RFP's) comprising a means of a pre-programmed electronic guide (Wizard) as an aid in specifying and setting forth requirements, an ability to create individual line item requirements which require separately identified pricing in resulting proposals/bids, an electronic means of capturing and storing such generated documents, and a means of electronically distributing the resulting service request specification (SOW/RFP) to registered, qualified vendors.

5. A system as set forth in claim 4 whereby the creation of line item requirements provides a means for manual input to create and/or augment said line items.

6. A system as set forth in claim 4 whereby the distribution and notification of service requests to eligible vendors is determined and specified by the issuing party at the time of creation of said service request. These service request notifications may also be submitted to ineligible vendors as well, provided that the vendor rectifies the criteria corresponding to their ineligibility prior to their ability to respond to a request.

7. A system for determining the eligibility of vendors based on:
a vendor's selected industry/industries;
a vendor's selected service area and/or
geographic proximity to the service location;
submission of qualifying documentation, including but not limited to business and occupational license, general liability insurance, workers compensation insurance, professional license(s);other testaments to abilities to perform;
verification of validity of said documentation, and preferences of service requestor.

8. A system set forth in claim 7 whereby service requestor can register their preferences of service requestors through various designations of classification of vendor.

9. A system set forth in claim 7 whereby service requestors can manually prioritize the eligibility of various service providers, thereby determining the order and timing of notification of vendors of available jobs.

10. A system and method for qualified vendors to respond to requests for proposal comprising
an electronic means of notifying eligible vendors of the availability of such requests, a method for said vendors to electronically reserve one of the limited bidding slots (or reserve a limited bidding slot via the submission of a proposal), a means for said vendors to electronically submit responses, in a prescribed manner, to the line item requests set forth in the RFP.

11. A system and method that provides a means for vendors to electronically submit alternate proposals, and a means to allow for suggestions and descriptions of alternate methods and/or service content other than what was specified in the original RFP.

12. A system and method set forth in claim 1 whereby service requestors can immediately see participating vendor company and contact info as soon as that vendor expresses interest in a particular RFP.

13. A system and method set forth in claim 1 whereby a service requestor may view the prices of proposals submitted by vendors in real-time in the event that sealed bidding was not required.

14. A system and method set forth in claim 1 whereby a service requestor may withdraw sealed bidding requirements in order to immediately view the prices of proposals submitted by vendors in real-time in the event that sealed bidding was initially required.

15. A system and method set forth in claim 14 whereby “breaking the seal” of a sealed bid may be automatically annotated and disclosed in the electronic package via the system set forth in claim 3.

16. A system as set forth in claim 1 whereby a RFP may be replicated, updated and submitted in order to quickly adjust the requirements of a given project, or re-submit a similar RFP to vendors for another project or property.

17. A system as set forth in claim 1 whereby a RFP may be modified or otherwise updated that provides automatic notification to participating and/or eligible vendors as set forth in claim 7.

18. A system and method that rescinds the submittal status of a vendor's proposal in the event that a change to an RFP is made after a vendor initially submits a proposal, effectively un-submitting a previously submitted proposal so that the vendor may have the opportunity to review and modify their proposal to ensure that it properly and accurately reflects the amended RFP requirements.

19. A system as set forth in claim 7 whereby a vendor may be automatically notified of any deficiencies preventing the eligibility and participation of that vendor for a given RFP, such as for example notifying a vendor that if they increased their general liability insurance coverage policy amount that they would be eligible to participate in a given job.

20. A system and method that facilitates a user communication forum whereby a manager can post information for eligible or participating vendors to see, and vendor responses are only visible to the manager and not competing vendors.
